(19) United States
(12) Patent Application Publication
(10) Pub. No.: US 2015/0292824 A1
(43) Pub. Date: Oct. 15, 2015

(54) SUBSEA HEAT EXCHANGER, CLEANING TOOL AND APPURTENANT METHOD

(71) Applicant: Aker Subsea AS, Lysaker (NO)

(72) Inventors: Per Karsten Andersen, Hosle (NO); Kjell Olav Stinessen, Oslo (NO)

(73) Assignee: Aker Subsea AS, Lysaker (NO)

(21) Appl. No.: 14/375,233

(22) PCT Filed: Feb. 19, 2013
(86) PCT No.: PCT/NO2013/050031

§ 371 Date: Jul. 29, 2014

(30) Foreign Application Priority Data
Feb. 20, 2012 (NO) 20120173

(51) Int. Cl. F28G 1/02; B08B 9/04; B08B 9/032; F28G 15/02; F28G 1/16

(52) U.S. Cl. CPC F28G 1/02; F28G 15/02; F28G 1/163; B08B 9/0321; B08B 9/04; F28F 2009/226

(57) ABSTRACT

Subsea heat exchanger (1) cooling a hydrocarbon-containing fluid by flowing seawater through it. Cooling pipes (4) are arranged in a convection section (11). The heat exchanger has an inlet (5a) and an outlet (5b) for the hydrocarbon-containing fluid, and an inlet (21) and outlet (22) for seawater. The seawater inlet (21) is connected to the cooling pipes (4). The inlet (5a) and the outlet (5b) of the hydrocarbon-containing fluid are connected to the convection section (11). The seawater can flow through the cooling pipes (4) and the hydrocarbon-containing fluid can flow in the convection section (11) in contact with the outer walls of the cooling pipes (4). The heat exchanger comprises also a cap (6) at at least one end of the cooling pipes (4), wherein the cap (6) comprises one or more receiving arrangements (8) for anodes (7) and/or one or more anodes (7).

The present invention relates to a heat exchanger, in particular a heat exchanger which is suitable for use at the seabed.

### BACKGROUND

Arrangements for heat exchanging are known and exist in many embodiments. They are used daily in many contexts. The purpose of the present invention is to perform temperature exchange between two media at the seabed by using the water as cooling medium. Most relevant is use in offshore installation at the seabed having need for cooling of a hydrocarbon-containing fluid.

There is a plurality of challenges associated with heat exchangers on the seabed. They are exposed to corrosion on most metal surfaces and marine fouling and lime scaling occur. This type of fouling may significantly reduce the effectiveness of the heat exchanger. Maintenance of heat exchangers arranged on the seabed normally requires that equipment is retrieved to the surface, something which may cause operation stoppage for the rest of the facility. Such types of activity performed at sea are often time consuming and expensive.

Desired features for a subsea located heat exchanger comprises effective heat transfer, limited size and weight, limited need for maintenance, and that maintenance may be performed on location without having to move it to the surface. An additional desired property is that it may be disconnected from the other parts of an installation and be transported to the surface with least possible impact on the operation of the installation.

Since fouling and lime deposits is a problem for subsea heat exchangers, there is also a need for a cleaning tool that may be used for maintenance of the subsea heat exchanger without disturbing operation of the installation unnecessary.

International patent publication WO2010002272 describes a subsea heat exchanger where a plurality of flow pipes, adapted for conduction of a hydrocarbon containing fluid, are enclosed in an enclosure. The publication describes further that there is arranged a pump for forced flow-through of water through the enclosure.

US patent application US20040238161 describes a so called “shell-and-tube” heat exchanger, where seawater is guided through a plurality of straight pipes that are arranged in a cylindrical jacket. Warm fluid is guided into the jacket and out of it after having been cooled against the cooling pipes in the jacket.

The publications SU1285303A1, CN202048835U, JP57169596A also describe a heat exchanger having a cylindrical jacket through which straight pipes extend.

The publication GB1472599A describes a heat exchanger for heating of a fluid, wherein the heat exchanger is attached to a cleaning arrangement.

The publication U.S. Pat. No. 5,022,463A also describes a heat exchanger having a plurality of straight and parallel fluid channels for guiding fluid.

The publication U.S. Pat. No. 3,794,051 A describes a cleaning tool for cleaning the inside of fluid conducting pipes.

### THE INVENTION

According to a first aspect of the present invention there is provided a subsea heat exchanger adapted for cooling of a hydrocarbon-containing fluid by through-flow of surrounding seawater through the heat exchanger. The heat exchanger comprises a plurality of cooling pipes arranged in a convection section. The heat exchanger has an inlet and an outlet for the hydrocarbon-containing fluid, as well as an inlet and an outlet for the seawater. The inlet for the seawater is connected to the cooling pipes. The inlet and the outlet for the hydrocarbon-containing fluid are connected to the convection section. Seawater may thus flow through the cooling pipes and the hydrocarbon-containing fluid can flow in the convection section, in contact with the outer walls of the cooling pipes. According to the first aspect of the invention the heat exchanger further comprises a cap at at least one end of the cooling pipes, wherein the cap comprises one or more receiving arrangements for anodes and/or one or more anodes. Anodes arranged on the heat exchanger will contribute to corrosion protection when arranged in seawater.

Advantageously a water pump may be arranged in association with the inlet or outlet for the seawater, which is adapted to pump seawater from the inlet to the outlet, through the cooling pipes.

The heat exchanger may exhibit a first section and a second section and the cap may be arranged at one of these. The cap and an upper or lower end plate can enclose a distribution chamber arranged between the inlet or outlet of the seawater and the cooling pipes. The cap can then be adapted to be released from its position where it forms said distribution chamber together with the upper or lower end plate.

The cap may be adapted to be released from its position where it forms said distribution chamber together with the upper or lower end plate. This characteristic is important when cleaning the inside of the cooling pipes. This will be described in closer detail below. The cap can then advantageously be attached to the rest of the heat exchanger by means of a hinge, so that it may be pivoted to a position where the inside of the cooling pipes is exposed. This will simplify removal and remounting of the cap from and back onto, respectively, its position where it forms the distribution chamber. This will typically be performed by means of a remotely operated vehicle (ROV).

The term cap shall be construed as any kind of component that contributes to enclose the distribution chamber. It may hence be a lid, cover, jacket, or any other type of arrangement that provides this function.

The heat exchanger preferably comprises two steering arrangements, for example in the form of guiding rings which are adapted for engagement with guiding arrangements, such as guiding posts. There may also advantageously be arranged two sets of steering arrangements, where each set is arranged at the same position on the heat exchanger, however with an axial distance between each set.

One end of the cooling pipes is arranged at the distribution chamber and the opposite ends of the cooling pipes can then advantageously face towards the surrounding seawater. In order to pump seawater through the cooling pipes it suffices that only one distribution chamber is arranged at one of the two ends of the cooling pipes. With the term “face surrounding seawater”, it is here meant that there is not arranged any further arrangements for guiding the water flow that exits the cooling pipes. This water thus flows directly out into the seawater that surrounds the heat exchanger.

The heat exchanger can advantageously have an auxiliary inlet for insertion of chemicals to the convection section. This is useful when cleaning the convection section by means of chemicals or if one of other reasons wants to add something to the hydrocarbon-containing fluid.

One or both of the end plates may exhibit a first side that faces the convection section, which has a concave shape. Such a shape is appropriate at large pressures inside the convection section. Moreover, one or both of the end plates can advantageously exhibit a second side that faces oppositely of the convection section, which has a plane shape. Such a plane shape simplifies welding of the cooling pipes to the end plate at this plane surface.

According to a second aspect of the present invention there is arranged a subsea cleaning tool having
a plurality of cleaning pipes which at their first ends are fixedly attached to a holding arrangement in a mutually parallel orientation;
the cleaning pipes comprise cleaning heads at their second ends or in distance from their first ends and second ends, wherein the cleaning heads comprise cleaning equipment which is adapted for cleaning of the inside of pipes; and
a steering arrangement, for instance guiding rings, which are adapted for engagement with guiding arrangements, which may be guide posts, when using the cleaning tool at the seabed.

The term pipe may here, in some embodiments, also mean rods without inner bore. In the most preferred embodiments though, there are pipes having inner bore.

As will be appreciated by the person skilled in the art the cleaning tool according to the second aspect of the present invention will be particularly suited for cleaning the inside of the cooling pipes of the subsea heat exchanger according to the first aspect of the present invention. The cleaning tool can be landed on the heat exchanger when its cap is moved aside, and the cleaning pipes can be guided into the cooling pipes of the heat exchanger.

The cleaning tool according to the second aspect of the invention can advantageously comprise a lead plate having a plurality of holes through which the cleaning pipes extend, wherein the lead plate can be displaced axially with respect to the cleaning pipes. When the cleaning tool has landed on the heat exchanger, the lead plate can thus abut against the upper side (such as the end plate) of the heat exchanger and the cleaning pipes can be moved downwards with respect to the lead plate.

The cleaning tool can advantageously also comprise two or more steering arrangements, such as guiding rings, which are adapted for engagement with guiding arrangements, such as guiding posts, when using the cleaning tool at the seabed. When landing the cleaning tool on the heat exchanger the guiding rings can advantageously engage the same guiding posts as which the guiding rings of the heat exchanger are in engagement with. In this way mutual alignment of the cleaning tool with respect to the heat exchanger is provided. Such alignment is necessary in order to be able to move the cleaning pipes into the cooling pipes.

Furthermore, the cleaning tool can be characterized in that the cleaning heads are provided with cleaning equipment in the form of nozzles and/or brushes.

In addition the cleaning heads can be provided with a blocking in the form of a ring that circumvents the cleaning head, which blocking is adapted to substantially fill the annulus between the cleaning pipe and the inside of a pipe which is being cleaned. In this way possible added chemicals are maintained a longer time in the area that shall be cleaned and will not flow out into the seawater outside the heat exchanger at once.

According to a third aspect of the invention there is provided a method of cleaning of cooling pipes of a subsea heat exchanger which is installed at the seabed. The method is distinguished by the following steps:
a) lowering a cleaning tool from the surface down to the seabed, to a position above the heat exchanger;
b) lowering and aligning the cleaning tool so that a steering arrangement of the cleaning tool engages a guiding arrangement arranged at the seabed;
c) lowering the cleaning tool further until a plurality of cleaning pipes of the cleaning tool extend into cooling pipes of the heat exchanger;
d) performing cleaning of the inside of the cooling pipes by means of cleaning heads which are arranged on the cleaning pipes.

With the method according to the third aspect of the present invention the cleaning tool can advantageously be a cleaning tool according to the second aspect of the invention. Furthermore the heat exchanger can advantageously be a heat exchanger according to the first aspect of the invention.

This method can further be distinguished in that step d) comprises at least one of the following actions:
i) moving the cleaning pipes back and forth while they are arranged inside the cleaning pipes, for in this manner to brush the inside of the cooling pipes with brushes arranged on the cleaning heads;
ii) supplying pressurized liquid through the cleaning pipes and out of nozzles on the cleaning heads, for in this manner to flush the inside of the cooling pipes; and
iii) flowing cleaning chemicals through the cleaning pipes and out of the nozzles, for in this manner to clean the inside of the cooling pipes.

The invention allows for hydrocarbon-containing fluid to be guided through parts made of materials which are corrosion resistant with respect to those media they are exposed to. Water is guided through parts that not necessarily are corrosion resistant, but where corrosion protection is possible, and where other pollution can be removed with appropriate tool without destroying the heat exchanger. This tool can preferably also be used at the seabed, that is without having to pull the heat exchanger up to the surface. The heat exchanger can preferably be taken up to the surface if necessary.

### EXAMPLE DESCRIPTION

While the invention has been described generally above, a more detailed description of an example of embodiment will be given in the following with reference to the figures, in which

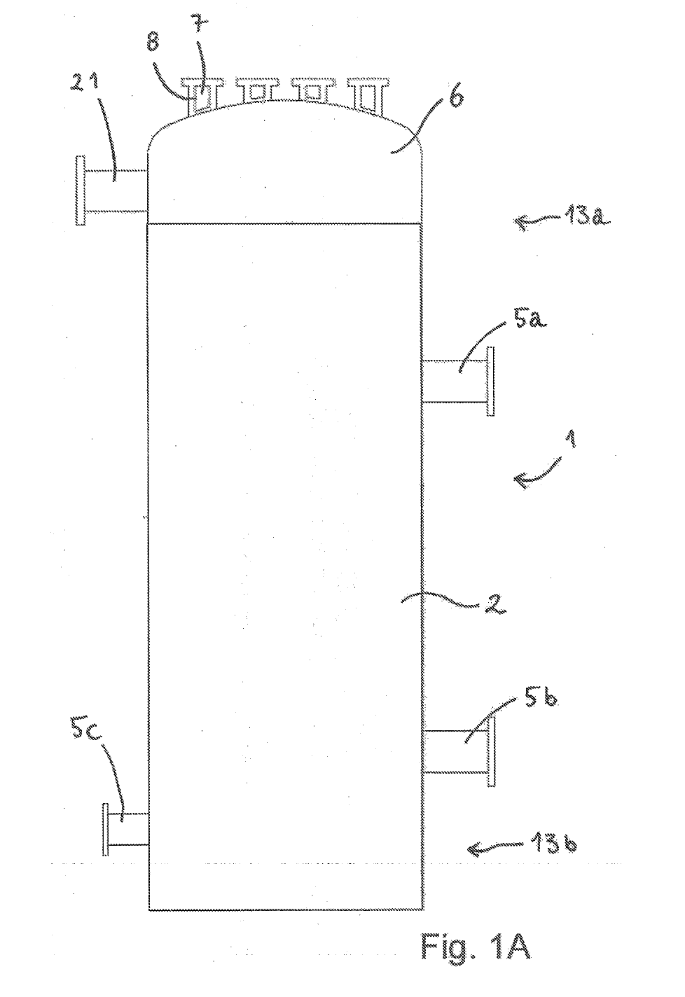

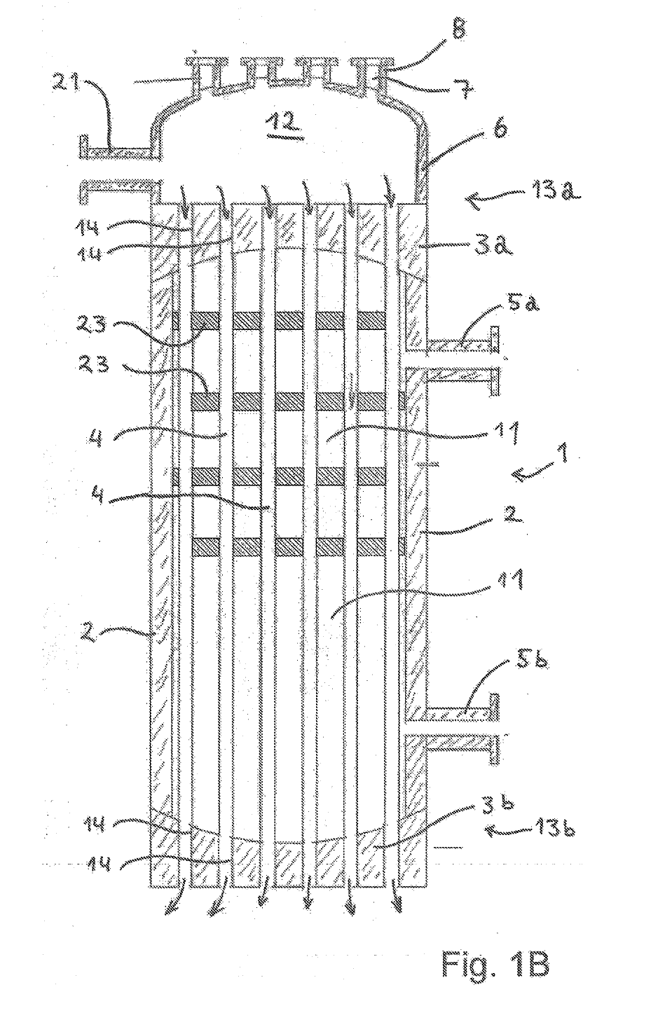

FIG. 1A shows a side view of a heat exchanger according to the invention;

FIG. 1B shows a cross section view of the heat exchanger in FIG. 1A;

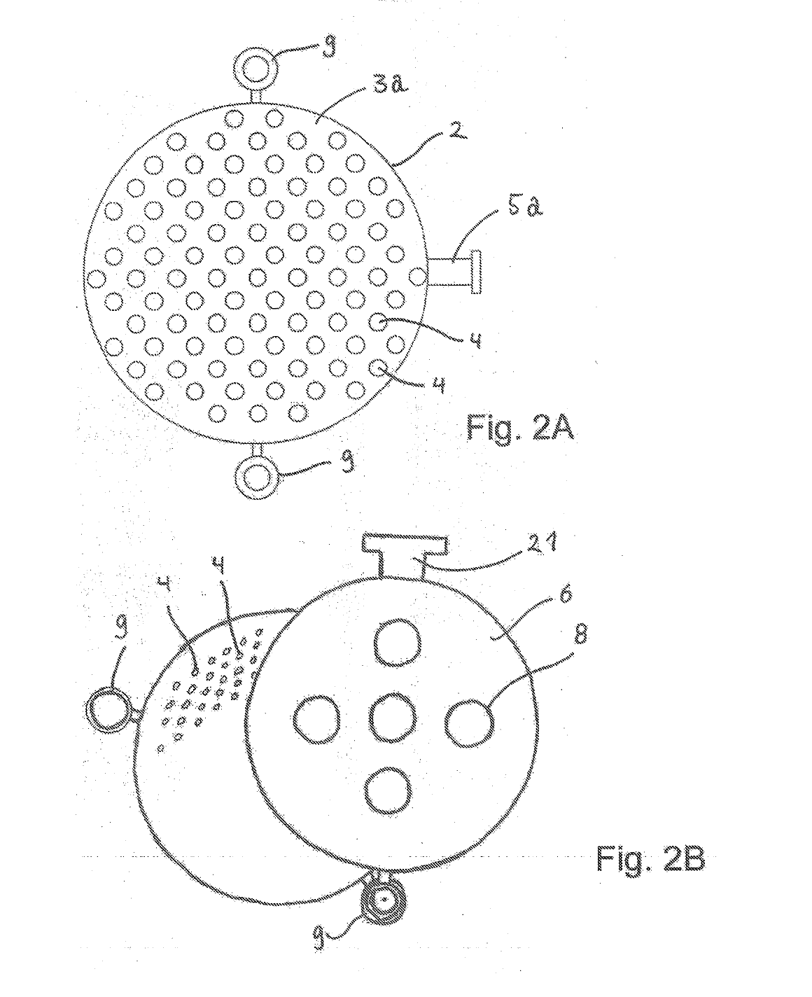

FIG. 2A shows a top view of the heat exchanger in FIG. 1A without the cap;

FIG. 2B shows another top view of the heat exchanger, with the cap pivoted a bit out of the position shown in FIG. 2A;

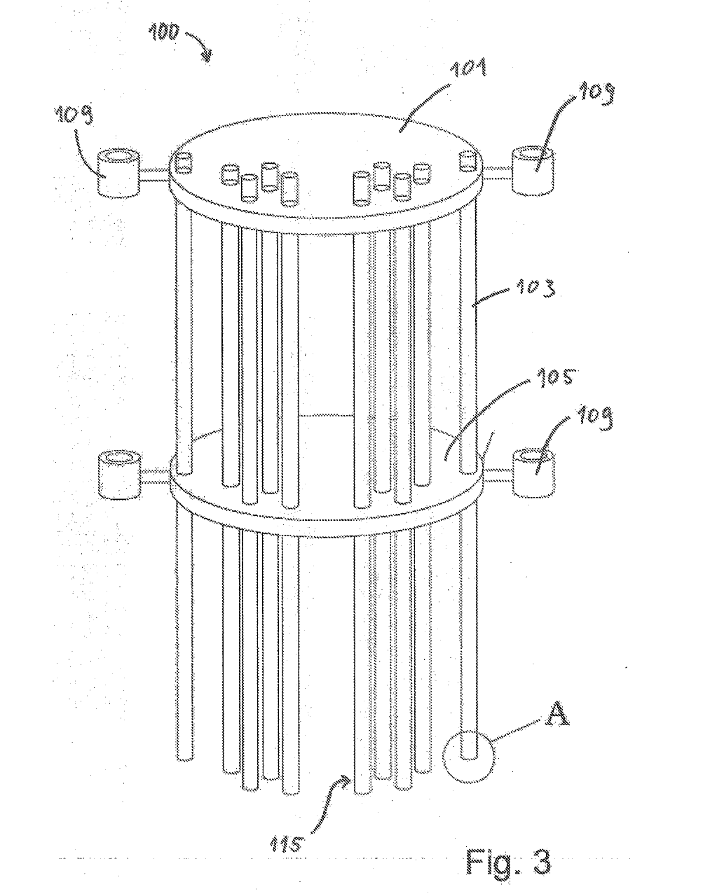

FIG. 3 shows a perspective view of a cleaning tool according to the invention; and

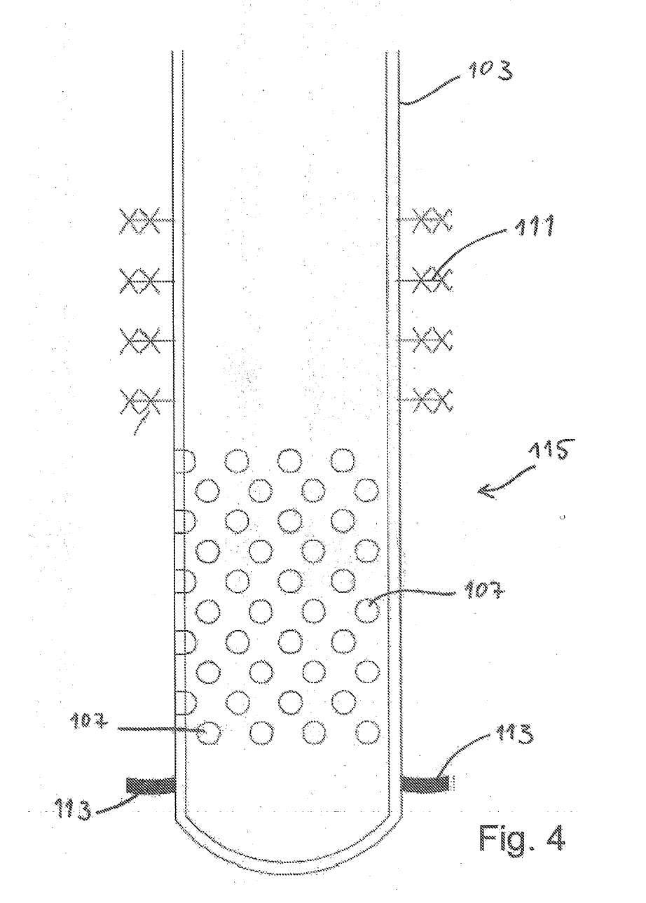

FIG. 4 shows an enlarged side view of a part of the cleaning tool in FIG. 3.

### HEAT EXCHANGER

FIG. 1A and FIG. 1B show a heat exchanger 1 according to the invention. The heat exchanger has an outer hull 2. The outer hull 2 is cylindrically shaped with a cylindrical cross section. In the upper and lower part of the cylindrical shape there is arranged an upper and lower end plate 3a, 3b, respectively. Inside the outer hull 2 there is further arranged a plurality of cooling pipes (FIG. 1B). Fluid which shall be cooled, typically a hydrocarbon-containing fluid, is guided into a fluid inlet 5a and out of a fluid outlet 5b. The fluid inlet 5a and the fluid outlet 5b are in form of pipe sockets that are connected to the outer hull 2. As will be appreciated by the person skilled in the art, the fluid outlet and fluid inlet 5a, 5b could switch places. The upper end plate 3a, the lower end plate 3b and the outer hull 2 hence encloses a convection section 11 through which the cooling pipes 4 extend.

In addition to the fluid inlet 5a and the fluid outlet 5b, which leads into the convection section 11, the heat exchanger 1 is also provided with an auxiliary inlet 5c. The auxiliary inlet 5c is useful when adding hydrate-removing chemicals or other types of chemicals into the convection section 11 for maintenance of the heat exchanger 1. The auxiliary inlet 5c can for instance be adapted to be connected by means of a remotely operated vehicle (ROV). There may also be additional auxiliary inlets 5c, and/or it may be located in another position, for instance closer to the first (upper) section 13a of the heat exchanger 1.

The heat exchanger 1 is adapted to be placed on the seabed, surrounded by seawater. For cooling of the fluid that shall be cooled in the heat exchanger 1, water from the surroundings is guided through the cooling pipes 4. Axially above the upper end plate 3a there is mounted a cap 6. The cap 6 is connected to a pump (not shown), which presses or sucks water through the cooling pipes 4. The pump is connected to a water inlet 21 that extends horizontally out from the cap 6. The heat exchanger 1 also has a water outlet 22, which is shown most clearly in FIG. 1B.

The cooling pipes 4 extend mainly parallel with respect to each other between a first section 13a and a second section 13b of the heat exchanger. In this embodiment the first and second section 13a, 13b is an upper and lower section, respectively. Advantageously they have a mutual distance so that the fluid which shall be cooled can flow between the cooling pipes 4.

It is now referred to FIG. 1B, which shows a cross section view of the heat exchanger 1. In this embodiment the cap 6 is arranged in association with the upper section (first section) 13a of the heat exchanger. The cap forms a distribution chamber 12 (see FIG. 1B) into which the water flows from the water inlet 21. From the distribution chamber 12 the water flows into channels 14 in the upper end plate, and further into the separate cooling pipes 4. The cooling pipes 4 are attached to the upper end plate 3a so that they are aligned with the channels 14 which extend through the upper end plate 3a.

As will be appreciated by the person skilled in the art, a cap such as the cap 6 shown in FIG. 1A and FIG. 1B could also be arranged in association to the second section 13b (lower section) of the heat exchanger. The pump (not shown) would also then be arranged in association to the cap.

Corresponding to the upper end plate 3a, the lower end plate 3b has through channels 14 which are aligned with the cooling pipes 4. If the cap 6 is removed, one would thus see through the heat exchanger 1, through the cooling pipes 4. The lower ends of the through channels 14 of the lower end plate 3b constitute the water outlet 22 in this embodiment.

The upper and lower end plate 3a, 3b exhibit a concave shape. This means that they are thinner at their middle portions than they are in their outer portions. Consequently the channels 14 are shorter in the middle area than in the outer areas. The concave shape of the upper and lower end plate 3a, 3b is appropriate in order to withstand large pressures in the fluid which shall be cooled, for instance a hydrocarbon-containing fluid from a subsea well flow. The cooling pipes can advantageously be attached to the upper and lower end plate 3a, 3b by means of welding.

When assembling the heat exchanger 1 the cooling pipes can be welded to the upper and lower end plate 3a, 3b. It will be advantageous to do this from the “outside”, namely at the plane surface of the end plate 3a, 3b. This corresponds to the end part of the cooling pipes 4. Welding of the cooling pipes 4 to the end plated 3a, 3b in this area will result in a small slit between the end plates 3a, 3b and the cooling pipes 4. With a heat exchanger having seawater in the convection section 11, these slits could function as a corrosion trap. However, since the heat exchanger 1 according to the present invention is adapted to have hydrocarbon-containing fluid in the convection section 11 and hence in such possible slits, this will not result in corrosion problems.

The cap 6 is releasably attached to the rest of the heat exchanger 1. The cap 6 can advantageously be attached to the heat exchanger 1, for instance to the upper end plate 3a, by means of hinges (not shown). One may for instance arrange hinges between the cap 6 and the outer shell 2 in such a way that the cap 6 can pivot about a horizontal axis, for instance 180°. The cap 6 can advantageously be removed or moved out of the position shown in FIG. 1A and FIG. 1B by means of a remotely operated vehicle (ROV). When the cap 6 is removed from the position where it covers the cooling pipes 4, respectively the upper end plate 3a, the inside of the cooling pipes can be cleaned by means of a suitable cleaning tool. This will be described later. If the cap 6 is arranged at the lower (second) section 13b of the heat exchanger 1, one could clean the inside of the cooling pipes 4 from above without having to remove the cap 6 from its position.

FIG. 2A shows the heat exchanger 1 seen from above with the cap 6 removed. The cap 6 can thus either be entirely removed from the heat exchanger 1 or be pivoted to the side about its hinged attachment to the upper end plate 3a or other parts of the heat exchanger 1.

FIG. 2B shows an embodiment of the heat exchanger 1 seen from above, where the cap 6 is partially pivoted to the side about a pivot axis that extends through a guiding ring 9. In this embodiment the cap 6 hence pivots about a vertical axis with a horizontal pivoting movement. As also can be seen from FIG. 2B the guiding rings 9 are asymmetrically arranged on the heat exchanger 1. One can also see sockets 8 that are arranged for mounting of anodes.

The cap 6 is provided with one or more anodes 7 for cathodic protection of the cooling pipes 4. The anodes 7 are mounted in sockets 8 which are attached to the cap 6. The anodes 7 are replaceable by means of remotely operated equipment.

The heat exchanger 1 is equipped with external guiding rings 9 for mounting on a foundation or base frame on the seabed which has pre-mounted guide posts (not shown) that extend vertically upwards. This facilitates landing of the heat exchanger on the seabed, for instance with the aid of an ROV. Two guiding rings 9 are shown in the schematic top view of FIG. 2, which shows the heat exchanger 1 from above with the cap 6 removed. Laterally extending out from the circular, cylindrical outer hull 2 of the heat exchanger 1 there is also shown the fluid inlet 5a (for the fluid which shall be cooled). Since the heat exchanger 1 in this embodiment is open in the bottom, one can see straight through the heat exchanger through the plurality of cooling pipes 4, as mentioned above.

One may also imagine that the heat exchanger 1 is provided with a cap in connection with both the first section 13a and the second section 13b, i.e. both in the upper section and the lower section, in the embodiment shown in FIG. 1A and FIG. 1B.

The outer shell 2 can also have other designs than what is shown herein. The circular cylindrical shape shown in the example of embodiment is however particularly appropriate for providing a heat exchanger 1 that can withstand high inner pressures.

With the heat exchanger 1 described with reference to FIG. 1A, FIG. 1B, and FIG. 2, there is provided a heat exchanger where the cooling water is guided on the inside of the pipes. Fouling and scaling in the heat exchanger will consequently occur on the inner side of the pipes. Heat exchangers where the cooling water flows along the outer side of the cooling pipes will, contrary to this, be exposed to fouling and lime scaling on the outer side of the pipes.

In the cross section view of the heat exchanger 1 shown in FIG. 1B there is indicated four guide plates 23. Advantageously the heat exchanger 1 may be provided with more than four such guide plates 23, even if only four are shown in FIG. 1B. The guide plates 23 in this example of embodiment extend crosswise to the direction of the cooling pipes 4. They are arranged on alternating different inner sides of the heat exchanger 1 and provide distribution of the flow of the medium that shall be cooled by the heat exchanger 1. In this manner a good heat transfer from the medium which shall be cooled to the cooling pipes 4 is provided. The flow pattern which is caused by the guide plates 23 is assumed also to contribute to reduced risk of hydrate formation in the heat exchanger 1 when it is used for cooling of the hydrocarbon-containing fluids. Addition of hydrate-inhibiting chemicals, such as MEG, becomes more evenly distributed due to the guide plates 23. The shape of the guide plates 23 can be chosen as appropriate by a person skilled in the art, in such manner that they do not prevent sufficiently through-flow of the fluid which shall be cooled and simultaneously provide a good distribution of the flow.

### Cleaning Tool

Exposure of/laying open the upper end plate 3a by removal of the cap 6 makes maintenance of the cooling pipes 4 possible without having to retrieve the heat exchanger 1 to the surface. Cleaning the inside of the cooling pipes 4 by means of a cleaning tool can thus be performed while the heat exchanger remains at its installed place at the seabed. The cleaning can in theory be performed even if fluid flows through the heat exchanger, between the fluid inlet 5a and the fluid outlet 5b. The cooling of the fluid that flows through the heat exchanger may of course then be reduced since water is not pumped through the cooling pipes.

FIG. 3 shows a perspective view of a cleaning tool 100 which is suited for cleaning of the inner surfaces of the cooling pipes 4 of the heat exchanger 1 described above. The cleaning tool 100 comprises a holding plate 101. The holding plate 101 has substantially the same diameter as the upper end plate 3a of the heat exchanger 1. Down from the holding plate 101 a plurality of cleaning pipes 103 extends. The cleaning pipes 103 are fixedly attached to the holding plate 101, for instance by welding. The cleaning pipes 103 are arranged in such a mutual position that they can simultaneously extend into all the cooling pipes 4 of the heat exchanger 1. One can also imagine a cleaning tool having fewer cleaning pipes than the number of cooling pipes 4 in the heat exchanger 1. In FIG. 3 only some of the cleaning pipes 103 are shown.

In a position at a distance down on the cleaning pipes 103, they extend through a lead plate 105. In the same manner as the holding plate 101, the lead plate 105 exhibits a plurality of holes through which the cleaning pipes 103 extend. The cleaning pipes 103 are however not fixedly attached to the lead plate 105. The cleaning pipes 103 are able to slide through the holes in the lead plate 105. There may also be arranged more than one lead plate 105.

Both the holding plate 101 and the lead plate 105 are preferably provided with a steering arrangement in the form of guiding rings 109, in the same manner as the heat exchanger 1 (cf. FIG. 2). The guiding rings 109 of the cleaning tool 100 are adapted to engage the guide posts (not shown) on the same manner as the guiding rings 9 of the heat exchanger 1. The cleaning tool 100 is adapted to be lowered down onto the heat exchanger 1 when the cap 6 of the heat exchanger 1 is removed from the position above the cooling pipes 4. The guide posts hence ensure that the cleaning tool 100 is lowered onto the heat exchanger 1 in the correct position so that the cleaning pipes 103 are inserted into the cooling pipes 4. When lowering the cleaning tool 100 down onto the heat exchanger 1, the lead plate 105 will eventually abut the upper end plate 3a of the heat exchanger 1. The movement of the cleaning pipes 103 and the holding plate 101 can continue downwards until the holding plate 101 lands on the lead plate 105. The cleaning tool 100 is then in its lower position.

In order to prevent that the lead plate 105 falls down and out of engagement with the cleaning pipes 103, some of the cleaning pipes may be provided with collars (not shown) on which the lead plate 105 rests on when in the position shown in FIG. 3.

At the bottom portion of the cleaning pipes 103 they exhibit a cleaning head 115 which is provided with one or more types of equipment suitable for removal of marine fouling and/or scaling inside the cooling pipes 4. In this example of embodiment all the cleaning pipes 103 are provided with cleaning heads 115 having a plurality of types of cleaning equipment.

FIG. 4 schematically shows an enlarged view of a cleaning head 115 on the lower end of a cleaning pipe 103. The cleaning head 115 is provided with a plurality of nozzles 107 through which the operator can emit water jets or chemicals for removal of fouling or scaling on the inner surfaces of the cooling pipes 4. For addition of water under pressure or chemicals, the cleaning pipes 103 are connected to a water source or chemical source (not shown) at their upper ends, above the holding plate 101. In such an embodiment the cleaning pipes 103 hence exhibit an inner channel, in which case it may be appropriate to use a hollow pipe.

The cleaning head 115 shown in FIG. 4 is also provided with a set of brushes 111 that extend out from the outer surface of the cleaning pipe 103. The brushes 111 are only schematically illustrated in FIG. 4. When the cleaning pipe 103 is moved back and forth (up and down) inside the cooling pipe 4 of the heat exchanger 1, the brushes 111 will contribute in removing fouling or scaling. One can of course also imagine a cleaning tool 100 where the cleaning pipes are able to rotate about their own axes, so that the brushes 111 will function even without axial movement of the cleaning pipe 103.

Moving the cleaning pipes 103 into the cooling pipes 4 can take place with the help of the weight of the cleaning tool 100. One can also imagine a motion arrangement which upon actuation can force the cleaning pipes 103 into the cooling pipes 4.

For supplying pressurized fluid, such as water or cleaning chemicals, a manifold (not shown) can be arranged on the cleaning tool. The fluid can for instance be supplied down to the seabed through a flexible line and be connected by means of an ROV. One can also imagine other solutions for supplying such fluid, for instance from a receptacle connected to the cleaning tool 100.

Closer to the lower end of the cleaning pipe 103, respectively further down on the cleaning head 115 than the position of the nozzles 107, there is also arranged a blocking 113 of for instance flexible polymer. The blocking 113 surrounds the cleaning head 115 with its circular shape and has an outer diameter which substantially corresponds to the inner diameter of the cooling pipes 4. The blocking 113 will hence substantially fill the annulus between the cleaning head and the inner wall of the cooling pipe 4, and in this manner ensure that chemicals which flow out of the nozzles 107 remain in the same axial position with respect to the cleaning pipe 103, even during axial movement of the cleaning pipe 103 inside the cooling pipe 4. One can also imagine that the blocking 113 is arranged on the opposite side of the nozzles 107 than what is shown in FIG. 4, or that the cleaning heads 115 are provided with two or more blockings 113.

With the heat exchanger 1 according to the invention, as described in the example description above, and a cleaning tool according to another aspect of the invention, a heat exchanger which can be maintained without disassembly or retrieval to the surface is achieved. Moreover, it is possible to perform maintenance of the heat exchanger where the need is supposed to be largest, namely the surfaces which face seawater.

Moreover, if the heat exchanger of some reason is pulled up to the surface, it may also be cleaned here without disassembly.

1. A subsea heat exchanger adapted for cooling of a hydrocarbon-containing fluid by through-flow of surrounding seawater through the subsea heat exchanger, the subsea heat exchanger comprising:
a plurality of cooling pipes arranged in a convection section, which heat exchanger has an inlet and an outlet for the hydrocarbon-containing fluid, as well as an inlet and an outlet for the seawater, wherein:
the inlet for the seawater is connected to the cooling pipes; and
the inlet and outlet for the hydrocarbon-containing fluid is connected to the convection section;
so that the seawater can flow through the cooling pipes and the hydrocarbon-containing fluid can flow through the convection section in contact with the outer walls of the cooling pipes, wherein the subsea heat exchanger further comprises a cap at at least one end of the cooling pipes, wherein the cap comprises one or more receiving arrangements for anodes and/or one or more anodes.

2. The subsea heat exchanger according to claim 1, wherein there is arranged a water pump in association to the inlet or the outlet for the seawater, which water pump is adapted to pump seawater from the inlet to the outlet, through the cooling pipes.

3. The subsea heat exchanger according to claim 1, wherein it exhibits a first section and a second section and that the cap is arranged at one of these, which cap together with an upper or lower end plate encloses a distribution chamber arranged between the inlet or the outlet for the seawater and the cooling pipes wherein the cap is adapted to be released from its position where it forms said distribution chamber together with the upper or lower end plate.

4. The subsea heat exchanger according to claim 3, wherein the cap is attached to the rest of the subsea heat exchanger by means of hinge, so that it can be pivoted to a position where the inner of the cooling pipes are exposed.

5. The subsea heat exchanger according to claim 1, wherein it comprises two steering arrangements adapted for engagement with guiding arrangements.

6. The subsea heat exchanger according to claim 3, wherein one end of the cooling pipes is arranged at the distribution chamber and that the opposite ends of the cooling pipes face surrounding seawater.

7. The subsea heat exchanger according to claim 1, wherein it has an auxiliary inlet for insertion of chemicals to the convection section.

8. The subsea heat exchanger according to claim 3, wherein one or both end plates exhibit a first side which faces the convection section, which has a concave shape.

9. A subsea cleaning tool, comprising:
a plurality of cleaning pipes, which cleaning pipes at their first ends are fixedly attached to a holding arrangement in a mutually parallel orientation;
wherein the cleaning pipes comprises cleaning heads at their second ends or in distance from their first ends and second ends, wherein the cleaning heads comprise cleaning equipment which is adapted for cleaning the inside of pipes; and
a steering arrangement adapted for engagement with guiding arrangements when using the cleaning tool at the seabed.

10. The subsea cleaning tool according to claim 1, further comprising:
a lead plate with a plurality of holes through which the cleaning pipes extend, wherein the lead plate can be moved axially with respect to the cleaning pipes.

11. The subsea cleaning tool according to claim 9, wherein the cleaning heads are provided with at least one of the following cleaning equipment:
nozzles;
brushes.

12. The subsea cleaning tool according to claim 11, wherein the cleaning heads are provided with a blocking in the form of a ring that circumvents the cleaning head, which blocking is adapted to substantially fill the annulus between the cleaning pipe and the inside of a pipe that is being cleaned.

13. A method of cleaning cooling pipes of a subsea heat exchanger which is installed at the seabed, the method comprising:
a) lowering a cleaning tool from the surface down towards the seabed, to a position above the subsea heat exchanger;
b) lowering and aligning the cleaning tool so that a steering arrangement of the cleaning tool engages a guiding arrangement arranged at the seabed;
c) lowering the cleaning tool further until a plurality of cleaning pipes extend into cooling pipes of the subsea heat exchanger;
d) performing cleaning of the inside of the cooling pipes by means of cleaning heads which are arranged on the cleaning pipes.

14. The method according to claim 13, wherein step d) comprises at least one of the following actions:
i) moving the cleaning pipes back and forth while they are arranged inside the cooling pipes, for in this manner to brush the inside of the cooling pipes with brushes arranged on the cleaning heads;
ii) supplying pressurized liquid through the cleaning pipes and out of nozzles on the cleaning heads, for in this manner to flush the inside of the cooling pipes; and
iii) flowing cleaning chemicals through the cleaning pipes and out of the nozzles, for in this manner to chemically clean the inside of the cooling pipes.
